(19) United States
(12) Patent Application Publication
(10) Pub. No.: US 2008/0149246 A1
(43) Pub. Date: Jun. 26, 2008

(54) Sheathed thread for fabricating a tire, a tire provided with the sheathed thread, a device for fabricating the sheathed thread, and a method and an installation for fabricating the tire

(75) Inventors: Dominique Leblanc, Mozac (FR); Daniel Guinet, Clermont-Ferrand (FR); Henri Hinc, Romagnat (FR); Alain Legagneur, Mozac (FR)

Correspondence Address: COHEN PONTANI LIEBERMAN & PAVANE LLP, Suite 1210, 551 Fifth Avenue, New York, NY, 10176, US

(73) Assignee: Michelin Recherche et Technique S.A., Granges-Paccot (CH)

(21) Appl. No.: 11/986,810

(22) Filed: Nov. 26, 2007

Related U.S. Application Data
(60) Provisional application No. 60/899,858, filed on Feb. 5, 2007.

(30) Foreign Application Priority Data
Nov. 24, 2006 (FR) 06/55088

(51) Int. Cl. B60C 9/00; D02G 3/00; B29D 30/08

(52) U.S. Cl. 152/458; 428/375; 156/397; 156/117

(57) ABSTRACT

A sheathed thread comprises a bare thread coated in a rubber sheath. The sheath comprises a plurality of segments spaced apart from one another along the bare thread in such a manner that bare portions of thread alternate with sheathed portions of thread. The device for fabricating the sheathed thread comprises a sheathing chamber through which the thread passes. An isolator member is movable between a position in which it isolates the portion of the thread passing through the sheathing chamber from the rubber, and a position in which it puts the portion of the thread passing through the sheathing thread into contact with the rubber.

### RELATED APPLICATIONS

This application claims priority from U.S. Provisional Patent Application Ser. No. 60/899,858 filed Feb. 5, 2007 and French application no. 06/55088 filed on Nov. 24, 2006 the content of each of which is hereby incorporated by reference.

### FIELD OF THE INVENTION

The present invention relates to a sheathed thread for fabricating a tire, to a tire provided with the sheathed thread, to a device for fabricating the sheathed thread, and to a method and an installation for fabricating the tire.

### BACKGROUND OF THE INVENTION

A tire that comprises a casing reinforcement ply provided with a sheathed thread of the type comprising a bare thread covered in a rubber sheath is known in the state of the art. The term “thread” should be understood broadly herein. Thus, in the following description, the term “thread” is used to designate, for example, a monofilament thread, a multifilament thread, or twisted wire or yarn, or a cable. The thread may be made of one or more materials, such as for example, a textile material or a metal material, and it may optionally be treated. Sheathing the casing reinforcement thread improves bonding between the thread and the surrounding rubber, in particular when fabricating a tire blank.

To fabricate the sheathed thread, it is known to make use of a device, such as that described, for example, in FR-A-2 687 094, that comprises a sheathing chamber for feeding with rubber and through which the thread passes. The bare thread driven through the sheathing chamber becomes covered in rubber so as to obtain a sheathed thread at the outlet from the sheathing chamber.

In order to fabricate a tire having sheathed casing-reinforcement threads, it is known to use an installation of the kind described in particular in EP-A-1 590 169 that comprises means for laying the sheathed thread on the tire blank.

In that type of installation, the blank is generally carried by a removable rigid core that is movable in rotation and matching the shape of the blank so as to present the usual portions of a tire, and in particular a crown and two sidewalls. Prior to laying the casing reinforcement, the blank may comprise, for example, a layer of sealing rubber covered by a layer of rubber for bonding to the casing reinforcement and onto which the sheathed thread is to be laid. After the casing reinforcement has been laid, this layer is covered with other layers of rubber so as to be completely embedded in rubber.

In the installation as described in EP 1 590 169 the means for laying the sheathed thread comprise a thread guide member that is movable with back-and-forth reciprocating motion, in particular substantially between the two sidewalls of the blank.

Generally, the continuous sheathed thread forming the casing reinforcement extends from one sidewall to the other of the blank of the tire, passing over the crown, following a boustrophedon path so as to form go-and-return bends in the thread. These bends extend in a sidewall zone for securing the tire to a wheel rim. This zone of the tire is commonly referred to as the “low zone”.

Because different portions of a tire perform different functions (thus, for example, the crown of the tire provides contact between the tire and the ground, whereas the low zone of the tire connects the tire to the wheel rim), it is desirable to adapt the structures of the various portions of the tire as much as possible to their functions. This adaptation may consist in using different layers of rubber adapted to the different functions of the portions of the tire, and/or to using different means for connecting the casing reinforcement with the rubber in the different portions of the tire.

### OBJECTS AND SUMMARY OF THE INVENTION

One object of the invention is to enable the structure of the different portions of the tire, e.g. the crown and the low zone of the tire, to be adapted to their functions.

This and other objects are attained in accordance with one aspect of the invention directed to a sheathed thread for fabricating a tire of the above-specified type, wherein the sheath comprises a plurality of segments that are spaced apart from one another along the bare thread so that bare portions of the thread alternate with sheathed portions of the thread.

The alternating bare and sheathed portions make it possible to differentiate means for connecting the rubber and the thread forming the casing reinforcement according to the rubber of the different portions of the tire. Thus, the sheathed thread of the invention serves to adapt the structures of the different portions of the tire to their functions.

According to an optional characteristic of the thread of the invention, the sheathed portions are substantially identical in length.

Such a thread is particularly adapted to fabricating a tire since the bare and sheathed portions alternate periodically.

Another aspect of the invention is directed to a tire of the type comprising at least one sheathed thread for reinforcing the casing, wherein the sheathed thread is as defined above.

Such a tire presents portions in which the structures adapt as well as possible to the different functions they are to perform.

According to other characteristics of the tire of the invention that are optional:
the thread extends from one sidewall to the other of the tire, passing over the crown, following a boustrophedon path so as to form go-and-return bends of the thread, the bends coinciding with bare portions of the thread;
the thread extends from one sidewall to the other of the tire, passing over the crown, following a boustrophedon path so as to form go-and-return bends of the thread, the bends coinciding with sheathed portions of the thread; and
each bend is connected directly to a preceding bend and to a following bend respectively by a sheathed portion of thread and a bare portion of thread.

The various types of casing reinforcement as formed in this way by the different threads present structures that are different. Thus, two tires presenting two different types of casing reinforcement will have two different structures, each structure being adapted specifically to the functions it is to perform.

Another aspect of the invention is directed to a device for fabricating a sheathed thread comprising a bare thread coated in a rubber sheath, the device being of the type comprising a so-called stationary sheathing chamber for being fed with rubber and having the thread passing therethrough, wherein the device comprises a member for isolating from the rubber a portion of bare thread passing through the stationary sheathing chamber, referred to as the through portion of the thread, said isolator member being movable between:
an isolating position in which the through portion of the thread is isolated from the rubber; and
a contacting position in which the through portion of the thread is put into contact with the rubber.

Such a device is for fabricating a sheathed thread having bare portions corresponding to the through portions of the bare thread that pass through the stationary sheathing chamber while the isolator member is in its isolating position. These bare portions alternate with sheathed portions corresponding to the through portions of the bare thread that pass through the stationary sheathing chamber while the isolator member is in its contacting position.

According to an optional characteristic of the device of the invention, the isolator member is movable in translation between its isolating and contacting positions, in particular parallel to a direction that is substantially parallel to the travel direction of the thread through the stationary sheathing chamber.

Such an isolator member is simple to move between its isolating and contacting positions.

According to other characteristics of the device of the invention, that are optional:
the isolator member is generally tubular in shape, allowing the thread to pass axially through the isolator member, the isolator member comprising an internal recess through which the thread passes forming a so-called moving sheathing chamber, and at least one orifice forming a rubber passage between the stationary and moving chambers; and
the isolator member is for mutually separating upstream and downstream portions of the stationary sheathing chamber, the downstream portion of the stationary sheathing chamber being designed to have the thread passing therethrough, the isolator member comprising an orifice forming a passage for the rubber between the upstream and downstream portions of the stationary sheathing chamber.

According to another optional characteristic of the device of the invention, the device comprises means for imparting periodic reciprocating displacement to the isolator member.

The periodic reciprocating displacement means enable displacement to be imparted to the isolator member between its isolating and contacting positions at a given frequency.

According to other characteristics of the device of the invention, that are optional, the device comprises:
means for adjusting the frequency of the reciprocating displacement of the isolator member. These adjustment means enable the device to be adjusted in such a manner as to obtain a sheathed thread with bare portions and sheathed portions that alternate substantially at the frequency of the reciprocating displacement of the isolator member;
means for adjusting the amplitude of the reciprocating displacement of the isolator member. These means enable the device to be adjusted in such a manner as to define the respective lengths of the bare portions and the sheathed portions of the thread; and
means for adjusting the mean position of the isolator member relative to the stationary sheathing chamber. These means also enable the respective lengths of the bare portions and of the sheathed portions of the thread to be defined.

Advantageously, the means for adjusting the mean position of the isolator member relative to the stationary sheathing chamber comprise a first support carrying the means for imparting reciprocating displacement to the isolator member and mounted to move on a second support that is stationary relative to the stationary sheathing chamber.

According to another optional characteristic of the device of the invention, the means for imparting reciprocating displacement to the isolator member comprise a connecting rod and crank type assembly.

This assembly allows the isolator member to be displaced between the isolating and contacting positions by transforming the rotary motion of the crank into periodic reciprocating motion of the isolator member.

Advantageously:
the means for adjusting the frequency of the reciprocating displacement of the isolator member comprise means for adjusting the speed of rotation of the crank; and
the connecting rod and crank type assembly comprises a crank-forming disk, the means for adjusting the amplitude of the reciprocating displacement of the isolator member comprising means for adjusting the position of a hinge between the connecting rod and the crank.

Another aspect of the invention is directed to an installation for fabricating a tire, the installation being of the type comprising laying means for laying a sheathed thread on a tire blank, wherein the installation also comprises a device for fabricating sheathed thread as defined above continuously feeding the laying means.

This installation makes use of the advantages of the invention for fabricating the sheathed thread in association with conventional means for laying a sheathed thread on a tire blank.

According to an optional characteristic of the installation of the invention, the means for laying the sheathed thread comprise a guide member for guiding the thread that is movable with periodic back-and-forth reciprocating motion, in particular substantially between two sidewalls of the blank, the installation further comprising means for synchronizing the periodic reciprocating motion of the guide member with the reciprocating displacement of the isolator member.

Synchronization enables a sheathed thread fabricated by means of the device as described above to be laid in alternation by the laying means between the two sidewalls of the blank following periodic movement that is synchronized with the displacement of the isolator member determining both the periodicity and the respective lengths of the bare and sheathed portions of the thread.

According to another optional characteristic of the installation of the invention, the installation comprises means for displacing the laying means relative to the device for fabricating the sheathed thread and enabling the length of the path of the sheathed thread between said laying means and the fabrication device to be adjusted.

Another aspect of the invention is directed to a method of fabricating a tire of the type in which a sheathed thread is laid on a tire blank, wherein the sheathed thread is fabricated and laid continuously by means of an installation as defined above.

Such a method makes it possible for a sheathed thread having bare portions alternating with sheathed portions to be laid continuously on a tire blank with the structure of its different portions being adapted to their respective functions.

Another aspect of the invention is directed to a method of fabricating a tire of the type in which a sheathed thread is laid on a tire blank, wherein a sheathed thread comprising a bare thread coated in a rubber sheath is laid continuously, the sheath comprising a plurality of segments that are mutually spaced apart along the bare thread in such a manner that bare portions of thread alternate with sheathed portions of thread.

According to other characteristics of the method of the invention that are optional:
the thread is laid from one sidewall to another of the tire blank by passing over a crown of the blank, following a boustrophedon path so as to form go-and-return bends of the thread, the bends coinciding with the bare portions of the thread;
the thread is laid from one sidewall to another of the tire blank by passing over a crown of the blank, following a boustrophedon path in such a manner as to form go-and-return bends of the thread, the bends coinciding with sheathed portions of the thread, and
the thread is laid in such a manner that each bend is connected directly to a preceding bend and a following bend respectively by a sheathed portion of thread and a bare portion of thread.

### BRIEF DESCRIPTION OF THE DRAWINGS

The invention can be better understood on reading the following description given purely by way of non-limiting example and made with reference to the drawings, in which:

FIG. 1 is a perspective view of an installation for fabricating a tire of the invention;

FIG. 2 is a fragmentary view of the installation of the invention shown in FIG. 1;

FIG. 3 is a plan view partially in section of a device of the invention for fabricating a sheathed thread in the installation shown in FIG. 1;

FIGS. 4, 5, and 6 are section views of an insulation member of the device shown in FIG. 3 with the insulation member shown in different positions;

FIG. 7 is a diagram of a first mode of synchronization between the insulation member and the means for laying the sheathed thread in the installation of the invention;

FIG. 8 is an axial section view of a tire of the invention having a casing ply provided with a sheathed thread placed on a blank using the synchronization mode of FIG. 7;

FIGS. 9 and 10 are a diagram and view analogous to those of FIGS. 7 and 8 for a second mode of synchronization;

FIG. 11 is a diagram analogous to FIG. 7 showing a third mode of synchronization; and

FIG. 12 is a section view of a variant embodiment of the insulation member.

### DETAILED DESCRIPTION OF THE DRAWINGS

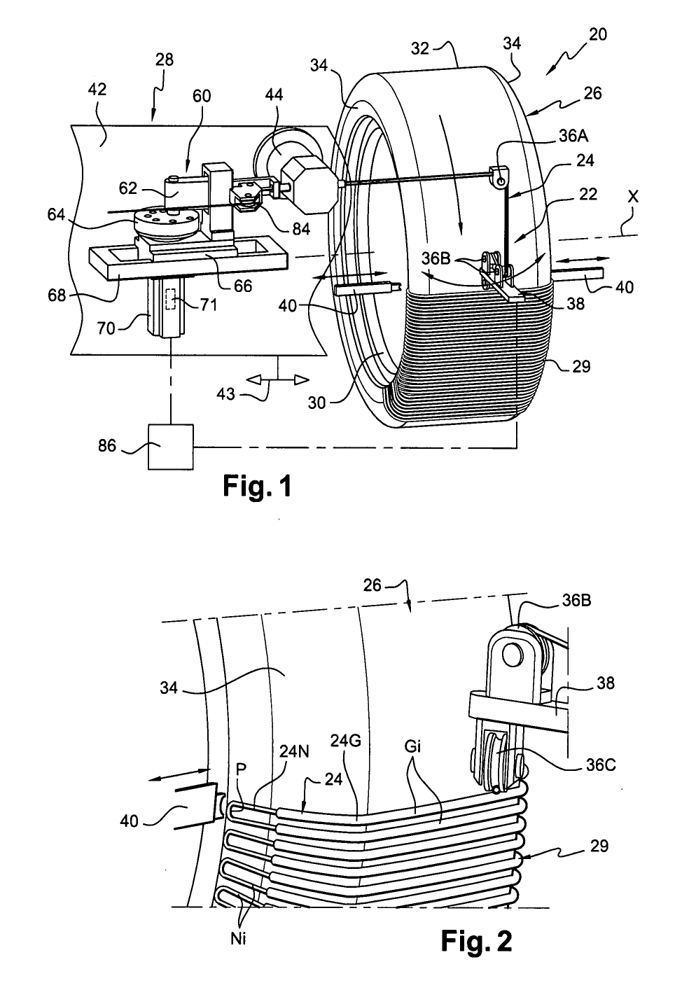

FIGS. 1 to 3 shows an installation of the invention given overall reference 20 for fabricating a tire. The installation 20 comprises means 22 for laying a sheathed thread 24 on a tire blank 26 and a device 28 for fabricating the sheathed thread 24. The sheathed thread 24 is for forming the casing reinforcement 29 of the tire. In FIGS. 1 and 2, this casing reinforcement 29 is shown while it is being fabricated on the blank 26.

The blank 26 is carried by a rigid removable core 30 shaping the blank 26 so that it presents a crown 32 and two sidewalls 34. The core 30 is rotatable about an axis X of the blank 26.

As can be seen in FIGS. 1 and 2, the laying means 22 comprise a plurality of pulleys 36A to 36C for guiding the sheathed thread 24. More particularly, in the example shown, the sheathed thread 24 is guided by an inlet pulley 36A, two intermediate pulleys 36B, and an outlet pulley 36C.

The laying means 22 also comprise a moving arm 38 presenting known motion enabling the thread to be laid on the surface of the tire blank and carrying the intermediate pulleys 36B and the outlet pulley 36C. The outlet pulley 36C can be moved with periodic back-and-forth reciprocating motion, in particular substantially between the two sidewalls 34 of the blank 36, passing over the crown 32.

The outlet pulley 36C forms a guide member for the thread 24 on the blank 26. More particularly, and as can be seen in particular in FIG. 2, the outlet pulley 36C guides the thread 24 from one sidewall 34 to the other of the blank 26, passing over the crown 32, following a boustrophedon path so as to form go-and-return bends P, forming zones in which the thread 24 passes in a go direction and in a return direction. Pressers 40 that are movable substantially axially relative to the blank 26 are placed in the vicinity of each of the sidewalls 34 of the blank 26. These pressers 40 enable the bends P of the thread to be formed on the sidewalls 34 of the blank 26.

In the example described, the sheathed thread 24 is laid substantially parallel to radial planes of the blank. In a variant, the thread 24 could be laid parallel to planes that are inclined relative to the axis X of the blank.

The thread 24 comprises a bare thread 24N covered in a rubber sheath 24G. The bare thread 24N comprises, for example, an optionally braided cable of metal and/or natural or synthetic fibers.

With reference for example to FIG. 2, it can be seen that the sheath 24G comprises a plurality of segments that are spaced apart from one another along the bare wire 24N so that the bare portions Nᵢ of the thread alternate with the sheathed portion Gᵢ of the thread.

With reference to FIG. 1, it can be seen that the device 28 for fabricating the thread 24 comprises a baseplate 42. The baseplate 42 is movable by conventional means 43 enabling the laying means 22 and the device 28 to move relative to each other, in particular for the purpose of adjusting the length of the path of the sheathed thread 24 between said lying means 22 and the device 28.

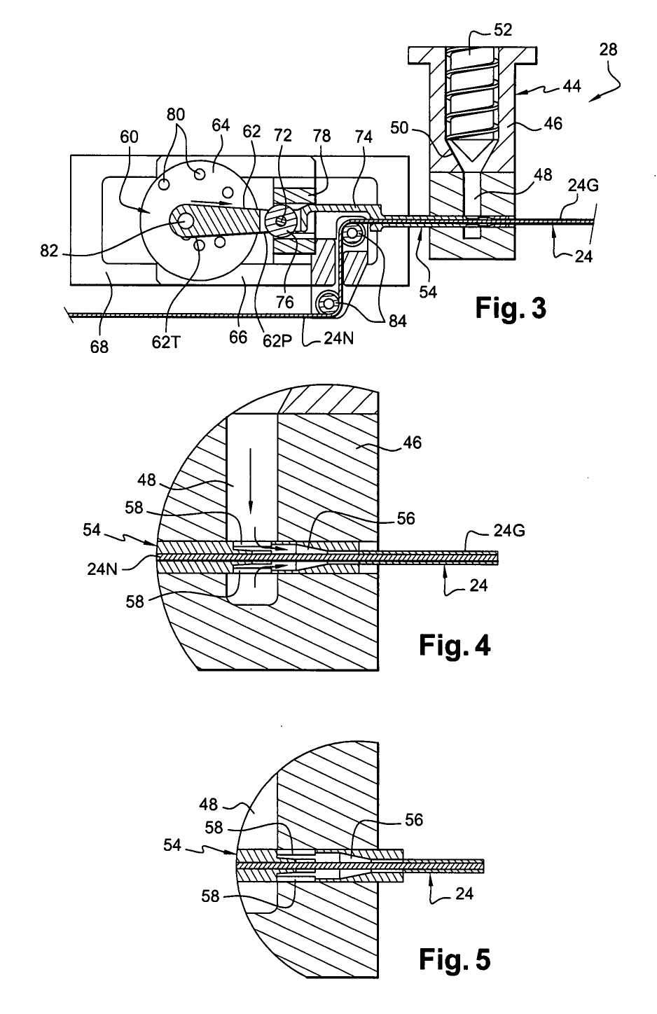

The baseplate 42 carries a housing 44 comprising a body 46 with two chambers formed therein, namely and as can be seen in FIG. 3: a stationary sheathing chamber 48 communicating with a rubber feed chamber 50.

The stationary sheathing chamber 48 serves firstly to be fed with rubber from the chamber 50, and secondly to have the thread 24 pass therethrough.

Heated rubber is introduced and pressurized in the chambers 48 and 50 by feed means 52 such as a wormscrew, for example. In order to obtain alternating bare portions N and sheathed portions G of the thread 24, the device 28 comprises an isolator member 54 passing through the stationary sheathing chamber 48. The member 54 serves to isolate a portion of the bare thread 24N passing through the stationary sheathing chamber 48 from the rubber, which portion is referred to as the through portion of the thread. This isolator member 54 can be moved in translation, in particular parallel to a substantially rectilinear travel direction of the thread 24 through the stationary sheathing chamber 48, between a position in which the through portion of the thread is put into contact with the rubber, as shown in FIG. 4, and a position in which the through portion of the thread is isolated from the rubber, as shown in FIG. 5 or FIG. 6.

The through portion of the thread 24 is sheathed when the isolator member 54 is in its contacting position and it is not sheathed when the isolator member 54 is in its isolating position.

With reference to FIGS. 4 to 6, it can be seen that the isolator member 54 is generally tubular in shape, allowing the thread 24 to pass axially through this isolator member 54.

The isolator member 54 comprises an internal recess through which the thread 24 passes and forming a moving sheathing chamber 56.

The isolator member 54 also comprises at least one orifice 58 forming a passage for rubber between the stationary and moving chambers 48 and 56. In the example shown, the isolator member 54 has four orifices 58, each generally in the form of a slot.

The baseplate 42 also carries displacement means 60 for moving the isolator member 54. As can be seen in FIGS. 1 and 3, the displacement means 60 are preferably of the periodic reciprocating type, and in the example shown they comprise an assembly of the connecting rod 62 and crank 64 type. In the example, the crank 64 is generally in the form of a disk.

In order to enable the mean position of the isolator member 54 to be adjusted relative to the stationary sheathing chamber 48, the connecting rod 62 and crank 64 assembly is carried by a first support forming a carriage 66 that is itself mounted to move on a second support 68 that is stationary relative to the stationary sheathing chamber 48. The second support 68 is secured to the baseplate 42.

The displacement means 60 also comprise motor-drive means 70 (see FIG. 1) driving the crank 64. The motor-drive means 70 are provided with conventional means 71 for adjusting the speed of rotation of the crank 64, thus providing means for adjusting the frequency of the periodic reciprocating displacement of the isolator member 54.

As can be seen in FIG. 3, a first hinge pin 72 connects a little end 62P of the connecting rod 62 to an extension 74 of the isolator member 54 outside the housing 44. This first hinge pin 72 is carried by a wheel 76 that co-operates with a member 78 secured to the carriage 66 and that contributes to guiding the isolator member 54 and the little end 62P of the connecting rod in translation.

Furthermore, the crank 64 has orifices 80 for hinging to a big end 62T of the connecting rod 62. These orifices 80 are distributed in a spiral on the crank 64 and form means for adjusting the amplitude of the reciprocating displacement of the isolator member 54. Specifically, each orifice 80 forms a housing for a second hinge pin 82 connecting the crank 64 to the big end 62T of the connecting rod 62. It is thus possible to modify the amplitude of the reciprocating displacement of the isolator member 54 by adjusting the position in which the connecting rod 62 is hinged to the crank 64 by changing the orifice 80 that receives the pin 82.

In the example described, the position of the hinge of the connecting rod 62 on the crank 64 is adjusted by using means that are discontinuous (the orifices 80). In a variant, the position of the hinge of the connecting rod 62 on the crank 64 could be adjusted using means that are continuous.

The device 18 also comprises pulleys 84 for guiding the thread 24 upstream from the sheathing chamber 48. These guide pulleys 84 are carried by the carriage 66.

The device 28 for fabricating the sheathed thread 24 feeds the laying means 22 continuously. Conventional means 86, shown diagrammatically in FIG. 1, serve to synchronize the periodic reciprocating motion of the guide member 36C with the reciprocating displacement of the isolator member 54. Thus, the installation 20 serves simultaneously to fabricate the sheathed thread 24 and to lay it on the blank 26, these two operations taking place continuously.

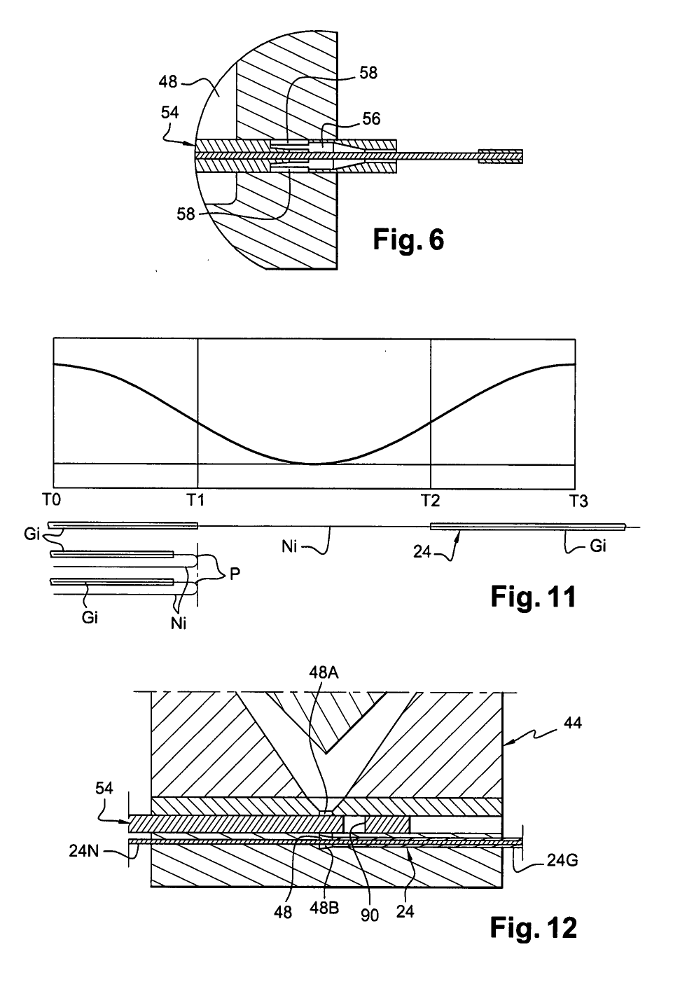

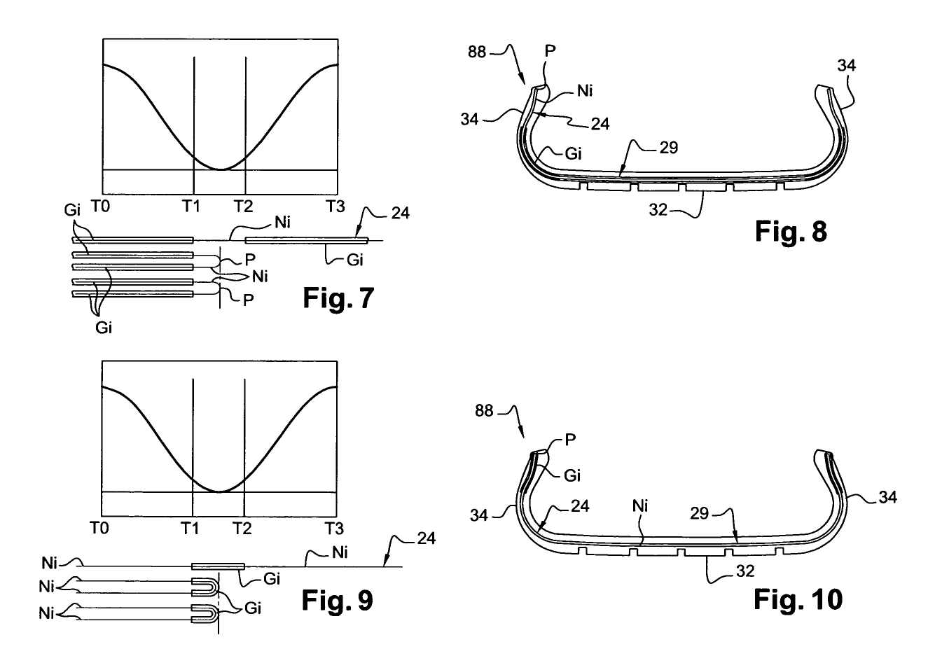

FIGS. 7, 9, and 11 show different embodiments of the thread 24 obtained by different adjustments of the fabrication device 28, and more particularly different adjustments of the motion of the isolator member 54 (in particular adjustment of the means 70, 71, and 80). It should be observed in these various modes, the sheathed portions Gᵢ of the thread 24 are of lengths that are substantially identical.

Furthermore, FIGS. 8 and 10 show a tire 88 in which the casing reinforcement 29 comprises the sheathed thread 24 obtained under the conditions of FIGS. 7 and 9, respectively.

In FIGS. 7 to 11, elements that are analogous are designated by references that are identical.

In each of FIGS. 7, 9, and 11, there can be seen a curve of generally sinusoidal appearance representing the variation as a function of time in the position of the isolator member 54 over one period of the reciprocating displacement of said member 54.

In the case of an adjustment of the kinematics of the isolator member 54 according to FIG. 7, then between times T1 and T2 of the period, the member 54 is in a position in which the chamber 56 is isolated from the chamber 48, and the thread 24N is isolated from the rubber, while during the remainder of the period T0 to T1 and T2 to T3), the member 54 is in a position that allows rubber to penetrate from the chamber 48 into the chamber 46 by passing through the orifices 58, thus putting the incoming rubber into contact with the bare thread 24N.

On leaving the fabrication device 28, the thread 24 presents appearance matching the segment of thread 24 shown immediately under the curve of FIG. 7: bare portions Nᵢ of the thread 24 alternate with sheathed portions Gᵢ of the thread 24.

Furthermore, the laying means 22 are synchronized with the fabrication device 28 and more particularly with the isolator member 54 in such a manner that the go-and-return bends P of the thread 24 coincide with the bare portions Nᵢ of the thread, as shown by the folded segments of the thread 24 shown under the curve of FIG. 7.

This produces a tire 88 as shown in FIG. 8 in which the sheathed thread 24 of the casing ply extends from one sidewall 34 to the other of the tire, passing over the crown 32 of the tire, following a boustrophedon path so that the folds P coincide with the bare portions Nᵢ of the thread.

In the case of an adjustment of the kinematics of the isolator member 54 according to FIG. 9, between times T1 and T2 of the period, the member 54 is in a position enabling rubber to penetrate from the chamber 48 into the chamber 56 on passing through the orifices 58, and while during the remainder of the period (T0 to T1, T2 to T3), the member 54 is in a position in which the chamber 56 is isolated from the chamber 48. On leaving the fabrication device 28, the thread 24 has an appearance matching the segment of thread 24 shown immediately under the curve of FIG. 9.

Nevertheless, unlike the configuration of FIG. 7, the laying means 22 are synchronized with the fabrication device 28 in such a manner that the bends P of the thread coincide with the sheathed portions Gᵢ of the thread, as shown by the folded segments of thread 24 shown under the curve of FIG. 9.

This produces a tire 88 as shown in FIG. 10: unlike the tire shown in FIG. 8, the bends P in the thread 24 coincide with sheathed portions Gᵢ of the thread.

In FIG. 11, the kinematics of the isolator member 54 is adjusted in a manner analogous to that of FIG. 7. Nevertheless, in FIG. 11, the time interval T1-T2 is longer than the time interval T1-T2 of FIG. 7. The bare portions Nᵢ of thread obtained under the conditions of FIG. 11 are thus longer than the bare portions Nᵢ of the thread obtained under the conditions of FIG. 7.

The laying means 22 are synchronized with the fabrication device 28 in such a manner that each bend P is connected directly to the preceding bend P and the following bend P via respective sheathed portions Gᵢ of the thread and a bare portion Nᵢ of the thread, as shown by the bent segments of thread 24 shown under the curve in FIG. 11.

A tire is thus obtained which, unlike the tire shown in FIG. 8, comprises a casing ply thread 24 in which each bend P is connected directly to a bend P that precedes it and to a bend P that follows it respectively by a sheathed portion Gᵢ of thread and by a bare portion Nᵢ of thread.

FIG. 12 shows a variant embodiment of the isolator member 54. In this figure, elements analogous to those of the preceding figures are designated by references that are identical.

In this example, the isolator member 54 separates upstream and downstream portions 48A and 48B of the stationary sheathing chamber 48. The downstream portion 48B of the stationary sheathing chamber 48 has the thread 24 passing therethrough.

The isolator member 54 has an orifice 90 forming a passage for rubber between the upstream and downstream portions 48A and 48B of the stationary sheathing chamber 48.

The operation of the isolator member 54 shown in FIG. 12 can be deduced, mutatis mutandis, from that of the isolator member shown in the preceding figures.

Amongst the advantages of the invention, it should be observed that it enables the structure of the different portions of the tire to be adapted to their functions. The various adjustment means of the fabrication device 28 make it possible to adjust the lengths of the bare and sheathed portions of the thread of the invention, depending on requirements.

The invention is not limited to the embodiments described above.

The rubber feed means 52 could be positive displacement type feed means enabling a quantity of rubber for sheathing the thread to be metered out continuously. Thus, it is possible to cause the quantity of rubber sheathing the thread to vary in such a manner that the diameter of the sheath of rubber around the thread is adapted to the radial position of the thread laid on the blank.

Furthermore, the periodic reciprocating displacement means 62, 64 could be other than a connecting rod and crank type assembly. Thus, the displacement means 62, 64 could comprise, for example, means having cams, solenoids, controlled motors, etc. Furthermore, the periodic reciprocating motion of the member 54 could be other than sinusoidal, for example it could present a squarewave configuration, at a frequency synchronized with the frequency of the means 22 for laying the thread.

What is claimed is:

1. A sheathed thread for fabricating a tire, the thread being of the type comprising bare thread coated in a rubber sheath, wherein the sheath comprises a plurality of segments that are spaced apart from one another along the bare thread so that bare portions of the thread alternate with sheathed portions of the thread.

2. The sheathed thread according to claim 1, in which the sheathed portions are substantially identical in length.

3. A tire of the type comprising at least one sheathed casing reinforcement thread, wherein the sheathed thread is according to claim 1.

4. The tire according to claim 3, in which the thread extends from one sidewall to the other of the tire, passing over the crown, following a boustrophedon path so as to form go-and-return bends of the thread, the bends coinciding with bare portions of the thread.

5. The tire according to claim 3, in which the thread extends from one sidewall to the other of the tire, passing over the crown, following a boustrophedon path so as to form go-and-return bends of the thread, the bends coinciding with sheathed portions of the thread.

6. The tire according to claim 5, in which each bend is connected directly to a preceding bend and to a following bend respectively by a sheathed portion of thread and a bare portion of thread.

7. An installation for fabricating a tire, the installation being of the type comprising laying means for laying a sheathed thread on a tire blank and a device for fabricating a sheathed thread comprising a bare thread coated in a rubber sheath, the device continuously feeding the laying means and comprising a so-called stationary sheathing chamber for being fed with rubber and having the thread passing therethrough, wherein the device comprises a member for isolating from the rubber a portion of bare thread passing through the stationary sheathing chamber, referred to as the through portion of the thread, said isolator member being movable between:
an isolating position in which the through portion of the thread is isolated from the rubber; and
a contacting position in which the through portion of the thread is put into contact with the rubber.

8. The installation according to claim 7, in which the means for laying the sheathed thread comprise a guide member for guiding the thread that is movable with periodic back-and-forth reciprocating motion, in particular substantially between two sidewalls of the blank, the installation further comprising means for synchronizing the periodic reciprocating motion of the guide member with the reciprocating displacement of the isolator member.

9. The installation according to claim 8, comprising means for displacing the laying means relative to the device for fabricating the sheathed thread and enabling the length of the path of the sheathed thread between said laying means and the fabrication device to be adjusted.

10. The installation according to claim 7, in which the isolator member is movable in translation between its isolating and contacting positions, in particular parallel to a direction that is substantially parallel to the travel direction of the thread through the stationary sheathing chamber.

11. The installation according to claim 10, in which the isolator member is generally tubular in shape, allowing the thread to pass axially through the isolator member, the isolator member comprising an internal recess through which the thread passes forming a so-called moving sheathing chamber, and at least one orifice forming a rubber passage between the stationary and moving chambers.

12. The installation according to claim 10, in which the isolator member is for mutually separating upstream and downstream portions of the stationary sheathing chamber, the downstream portion of the stationary sheathing chamber being designed to have the thread passing therethrough, the isolator member comprising an orifice forming a passage for the rubber between the upstream and downstream portions of the stationary sheathing chamber.

13. The installation according to claim 7, comprising means for imparting periodic reciprocating displacement to the isolator member.

14. The installation according to claim 13, comprising means for adjusting the frequency of the reciprocating displacement of the isolator member.

15. The installation according to claim 13, comprising means for adjusting the amplitude of the reciprocating displacement of the isolator member.

16. The installation according to claim 7, comprising means for adjusting the mean position of the isolator member relative to the stationary sheathing chamber.

17. The installation according to claim 16, in which the means for adjusting the mean position of the isolator member relative to the stationary sheathing chamber comprise a first support carrying the means for imparting reciprocating displacement to the isolator member and mounted to move on a second support that is stationary relative to the stationary sheathing chamber.

18. The installation according to claim 13, in which the means for imparting reciprocating displacement to the isolator member comprise a connecting rod and crank type assembly.

19. The installation according to claim 18, in which, the device comprising means for adjusting the frequency of the reciprocating displacement of the isolator member, the means for adjusting the frequency of the reciprocating displacement of the isolator member comprise means for adjusting the speed of rotation of the crank.

20. The installation according to claim 18, in which, the device comprising means for adjusting the amplitude of the reciprocating displacement of the isolator member, the connecting rod and crank type assembly comprises a crank-forming disk, the means for adjusting the amplitude of the reciprocating displacement of the isolator member comprising means for adjusting the position of a hinge between the connecting rod and the crank.

21. A method of fabricating a tire of the type in which a sheathed thread is laid on a tire blank, wherein the sheathed thread is fabricated and laid continuously by means of an installation according to claim 7.

22. A method of fabricating a tire of the type in which a sheathed thread is laid on a tire blank, wherein a sheathed thread comprising a bare thread coated in a rubber sheath is laid continuously, the sheath comprising a plurality of segments that are mutually spaced apart along the bare thread in such a manner that bare portions of thread alternate with sheathed portions of thread.

23. The method according to claim 22, in which the thread is laid from one sidewall to another of the tire blank by passing over a crown of the blank, following a boustrophedon path so as to form go-and-return bends of the thread, the bends coinciding with the bare portions of the thread.

24. The method according to claim 22, in which the thread is laid from one sidewall to another of the tire blank by passing over a crown of the blank, following a boustrophedon path in such a manner as to form go-and-return bends of the thread, the bends coinciding with sheathed portions of the thread.

25. The method according to claim 24, in which the thread is laid in such a manner that each bend is connected directly to a preceding bend and a following bend respectively by a sheathed portion of thread and a bare thread of thread.
